(19) United States
(12) Patent Application Publication
(10) Pub. No.: US 2026/0206082 A1
(43) Pub. Date: Jul. 16, 2026

(54) MULTI-AP MLD NETWORK RELIABILITY IMPROVEMENT

(71) Applicant: MEDIATEK INC., Hsinchu City (TW)

(72) Inventors: Yonggang FANG, San Jose, CA (US); James Chih-Shi YEE, San Jose, CA (US); Li-Hsiang SUN, San Jose, CA (US); Yongho SEOK, San Jose, CA (US)

(21) Appl. No.: 19/135,184

(22) PCT Filed: May 10, 2024
(86) PCT No.: PCT/CN2024/092285

§ 371 Date: Jun. 3, 2025

Related U.S. Application Data
(60) Provisional application No. 63/501,420, filed on May 11, 2023.

(51) Int. Cl. H04W 76/15; H04W 74/0808

(52) U.S. Cl. CPC H04W 76/15; H04W 74/0808

(57) ABSTRACT

Techniques pertaining to improvement of multi-access point (AP) multi-link device (MLD) network reliability in wireless communications are described. A station (STA) MLD acquires a coordinated transmission opportunity (C-TXOP) on multiple links. The STA MLD then communicates with multiple APs over the multiple links. Each of the multiple APs is affiliated with a respective AP MLD or Ultra-High Reliability (UHR) MLD and the multiple APs operate on a same channel in synchronization in a time domain.

### CROSS REFERENCE TO RELATED PATENT APPLICATION(S)

The present disclosure is part of a non-provisional patent application claiming the priority benefit of U.S. Provisional Patent Application No. 63/501,420 , filed 11 May 2023, the content of which herein being incorporated by reference in its entirety.

### TECHNICAL FIELD

The present disclosure is generally related to wireless communications and, more particularly, to improvement of multi-access point (AP) multi-link device (MLD) network reliability in wireless communications.

### BACKGROUND

Unless otherwise indicated herein, approaches described in this section are not prior art to the claims listed below and are not admitted as prior art by inclusion in this section.

In wireless communications, such as Wi-Fi (or WiFi) and wireless local area network (WLAN) based on one or more Institute of Electrical and Electronics Engineers (IEEE) 802.11 standards, a station (STA) normally has a lower transmission (Tx) power than that of an access point (AP), thereby causing unbalanced link budget between downlink (DL) and uplink (UL) transmissions. Consequently, the STA can receive a signal from the AP, such as Beacon frames or data frames, but the AP may not receive UL transmissions from the STA correctly. The unbalanced UL transmission may result in unreliability in UL transmissions. As unreliable UL transmissions may increase the possibility of roaming failure, there is a need for a solution of improvement of multi-AP MLD network reliability in wireless communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to provide schemes, concepts, designs, techniques, methods and apparatuses pertaining to improvement of multi-AP MLD network reliability in wireless communications. It is believed that, under various proposed schemes in accordance with the present disclosure, the aforementioned issue(s) may be addressed or otherwise alleviated. For instance, the various proposed schemes may leverage the diversity of distributed (or non-collocated) APs or AP MLDs in an Ultra-High Reliability (UHR) multi-AP (or mesh) system to improve UL transmission reliability and, thereby, improve the success rate of roaming by a STA among neighbor APs. Under the proposed schemes, multiple links of distributed (or non-collocated) neighboring APs may be set up or otherwise established on a same channel to reduce UL transmission failure on a single link. Additionally, under the proposed schemes, AP(s) with a better channel quality indicator (CQI), signal-to-interference-and-noise ratio (SINR) and/or signal-to-noise ratio (SNR) may be selected from the neighboring APs for frame exchange in a coordinated transmission opportunity (TXOP). Moreover, under the proposed schemes, AP(s) with a better CQI/SINR/SNR may be selected to schedule synchronized restricted target wake time (R-TWT) service period (SP) for frame exchange with the STA. Furthermore, under the proposed schemes, UL transmissions may be duplicated on selected link(s) on the multiple links to improve UL transmission reliability.

In one aspect, a method may involve a processor of a STA MLD acquiring a coordinated transmission opportunity (C-TXOP) with multiple APs on multiple links. The method may also involve the processor communicating with multiple APs over the multiple links. Each of the multiple APs may be affiliated with a respective AP MLD or UHR MLD and the multiple APs operate on a same channel in synchronization in a time domain.

In another aspect, an apparatus implementable in a non-AP MLD may include a transceiver and a processor coupled to the transceiver. The transceiver may be configured to communicate wirelessly. The processor may be configured to acquire a C-TXOP on multiple links. The processor may also be configured to communicate with multiple APs over the multiple links. Each of the multiple APs may be affiliated with a respective AP MLD or UHR MLD and the multiple APs operate on a same channel in synchronization in a time domain.

It is noteworthy that, although description provided herein may be in the context of certain radio access technologies, networks and network topologies such as, Wi-Fi, the proposed concepts, schemes and any variation(s)/derivative(s) thereof may be implemented in, for and by other types of radio access technologies, networks and network topologies such as, for example and without limitation, WiMax, Bluetooth, ZigBee, 5th Generation (5G)/New Radio (NR), Long-Term Evolution (LTE), LTE-Advanced, LTE-Advanced Pro, Internet-of-Things (IoT), Industrial IoT (IIoT) and narrowband IoT (NB-IoT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation to clearly illustrate the concept of the present disclosure.

FIG. 1 is a diagram of an example network environment in which various solutions and schemes in accordance with the present disclosure may be implemented.

FIG. 2 is a diagram of an example scenario in accordance with the present disclosure.

FIG. 3 is a diagram of an example scenario in accordance with the present disclosure.

FIG. 4 is a diagram of an example scenario in accordance with the present disclosure.

FIG. 5 is a diagram of an example scenario in accordance with the present disclosure.

FIG. 6 is a diagram of an example scenario in accordance with the present disclosure.

FIG. 7 is a block diagram of an example communication system in accordance with an implementation of the present disclosure.

FIG. 8 is a flowchart of an example process in accordance with an implementation of the present disclosure.

### DETAILED DESCRIPTION OF PREFERRED EMBODIMENTS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to improvement of multi-AP MLD network reliability in wireless communications. According to the present disclosure, a number of possible solutions may be implemented separately or jointly. That is, although these possible solutions may be described below separately, two or more of these possible solutions may be implemented in one combination or another.

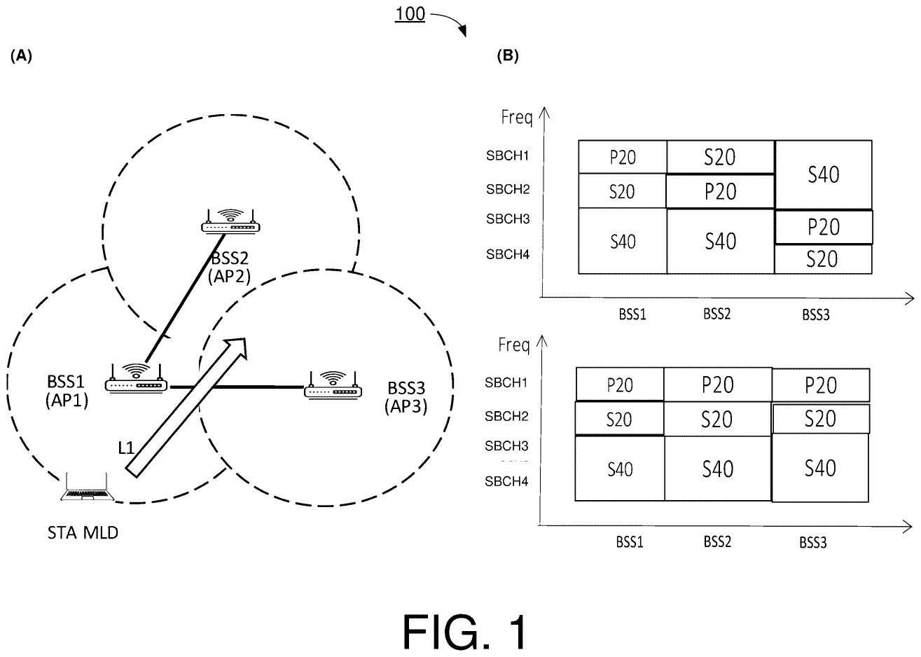

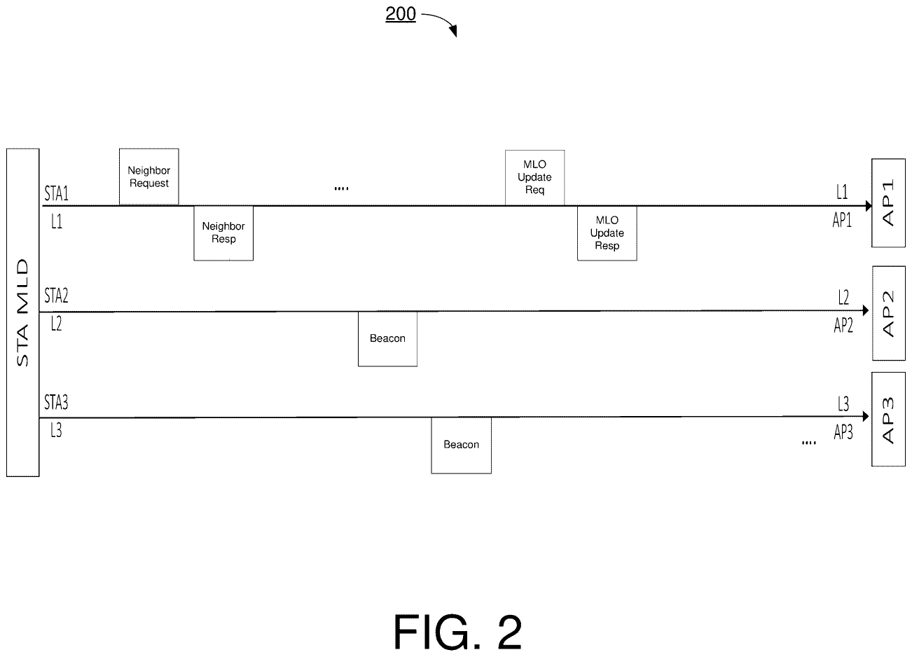

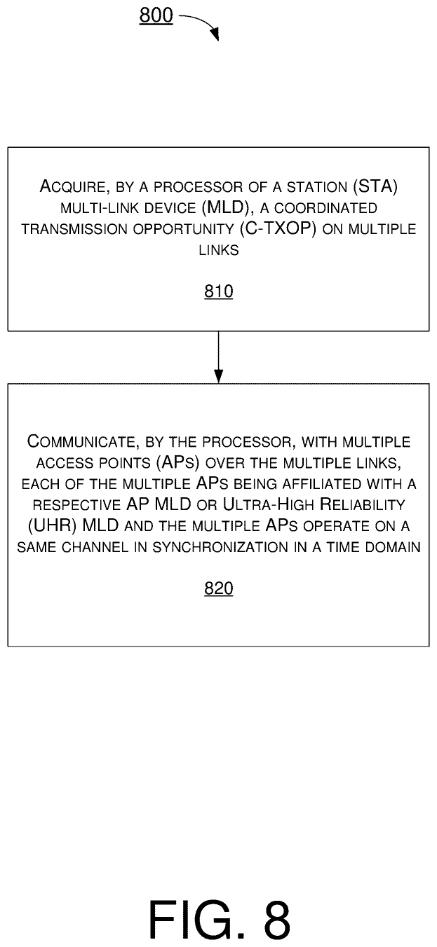

FIG. 1 illustrates an example network environment 100 in which various solutions and schemes in accordance with the present disclosure may be implemented. FIG. 2~FIG. 8 illustrate examples of implementation of various proposed schemes in network environment 100 in accordance with the present disclosure. The following description of various proposed schemes is provided with reference to FIG. 1~FIG. 8.

Referring to part (A) of FIG. 1, network environment 100 may involve a plurality of AP MLDs (or an UHR MLD) including, for example, AP MLD1, AP MLD2 and AP MLD 3. A respective basic service set (BSS) may correspond to a respective AP associated with each of the AP MLDs. For instance, BSS1 may correspond to AP1 associated with AP MLD1, BSS2 may correspond to AP2 associated with AP MLD2, and BSS3 may correspond to AP3 associated with AP MLD3. AP1, AP2 and AP3 may form or otherwise establish a multi-AP (MAP) configuration such that AP1, AP2 and AP3 may be neighboring APs and may operate on a same channel and be synchronized in the time domain. AP1 may function as an anchor AP, such as in a Multi-AP mesh network, and AP2 and AP3 may communicate with AP1 via backhaul links.

Referring to part (B) of FIG. 1, each BSS may have a respective primary channel (PCH) and secondary channels (SCHs) among a plurality of subband channels such as SBCH1, SBCH2, SBCH3 and SBCH4 in the operating channel bandwidth. The PCHs of neighboring BSS's may be configured in the same operating channel bandwidth on different subband channels or the same subband channel. In some implementations, each of BSS1, BSS2 and BSS3 may operate a respective PCH on a subband channel different than that of another BSS. For instance, BSS1 may operate a primary 20 MHz channel (P20) on SBCH1, a secondary 20 MHz channel (S20) on SBCH2 and a secondary 40 MHz channel (S40) on SBCH3 and SBCH4. Additionally, BSS2 may operate a P20 on SBCH2, a S20 on SBCH1, and a S40 on SBCH3 and SBCH4. Moreover, BSS3 may operate a P20 on SBCH3, a S20 on SBCH4, and a S40 on SBCH1 and SBCH2. In other implementations, each of BSS1, BSS2 and BSS3 may operate the respective PCH on the same subband channel. For instance, each of BSS1, BSS2 and BSS3 may operate a P20 on SBCH1, a S20 on SBCH2, and a S40 on SBCH3 and SBCH4.

Network environment 100 may also involve a STA MLD may associate with the UHR MLD via an AP affiliated with one of the AP MLDs (e.g., AP1 affiliated with AP MLD1). Multiple links may be set up or otherwise established between the STA MLD (e.g., STA1, STA2 and STA3 affiliated with STA MLD) and each of AP1, AP2 and AP3, respectively. For instance, STA1 affiliated with the STA MLD may initially set up one link (e.g., L1) with AP1 and then add and enable other links (e.g., L2 and L3 with AP2 and AP3, respectively) when moving from the coverage of AP1 to the coverage of another AP (e.g., AP2 or AP3). L1, L2 and L3 may be the extended link identifiers (E-Link IDs) of AP1, AP2 and AP3 associated with AP MLD1, AP MLD2 and AP MLD3, respectively in a UHR MAP system. For instance, E-Link ID=AP ID+AP MLD ID, and an E-Link ID subfield may be included in the A-Control, Multi-Link Element (MLE) or other fields.

In the examples described herein, AP1 (or AP MLD1) may be assumed as an anchor point of data connection to a distribution system (DS) for the STA MLD in the UHR MAP system. Accordingly, AP1 may perform the following operations: (1) detection and removal of duplicate medium access control (MAC) protocol data units (MPDUs); (2) forwarding UL data of STA MLD to the DS; and (3) maintaining an individual block acknowledgement (BA) score board for received MPDUs from AP1 and/or managing an MLD-level BA score board for consolidating the received MPDUS flushed from coordinated APs (C-APs) such as AP2 and AP3. Initially, AP1 may function as a serving AP (and AP2 and AP3 may function as coordinated APs) in implementing various proposed schemes in accordance with the present disclosure when STA MLD is within a coverage area of AP1. As STA MLD moves from the coverage area of AP1 to the coverage area of another AP (e.g., AP2 or AP3), that other AP (e.g., AP2 or AP3) may become the serving AP while the remaining neighboring APs may function as coordinated APs in implementing the various proposed schemes.

FIG. 2 illustrates an example scenario 200 under a proposed scheme in accordance with the present disclosure. Scenario 200 may pertain to discovery of neighboring BSS's and setup of multi-link (ML) connection(s). Referring to FIG. 2, a STA MLD may communicate with a UHR MAP system over a first link (e.g., L1), and STA1 affiliated with the STA MLD may send a Neighbor Request to AP1 to obtain information of neighboring APs (e.g., AP2 and AP3) from AP1 when the STA MLD expects to move out of the coverage area of AP1. Each of STA2 and STA3 affiliated with the STA MLD may receive a Beacon frame from AP2 and AP3, respectively, in overlapped coverage area(s). STA1 may send an MLO Update Request (or ML Reconfiguration Request) with parameters (e.g., Reconfiguration MLE containing Per-STA Profile of STA2 for L2 and/or Per-STA Profile of STA3 for L3) on L1 to add and enable L2 and/or L3 of AP2 and/or AP3 for a Multi-Link Operation (MLO). AP1 may communicate with AP2 and AP3 over backhaul connections about L2 and L3 setup and may receive confirmation from AP2 and AP3. AP1 may then send an MLO Update Response (or ML Reconfiguration Response) to STA1 on L1. Moreover, AP MLD1 may manage an MLD-level BA score board of reception status for consolidating received MPDUs forwarded by AP2 and AP3. After receiving a response from AP1, the STA MLD may update or reconfigure L2/L3 to AP2/AP3 on the same channel. Optionally, a coordination group of APs (e.g., AP1, AP2 and AP3) with the same BA policy and parameters may be formed for the STA MLD and assigned with a Multi-Cast (MC) MAC address.

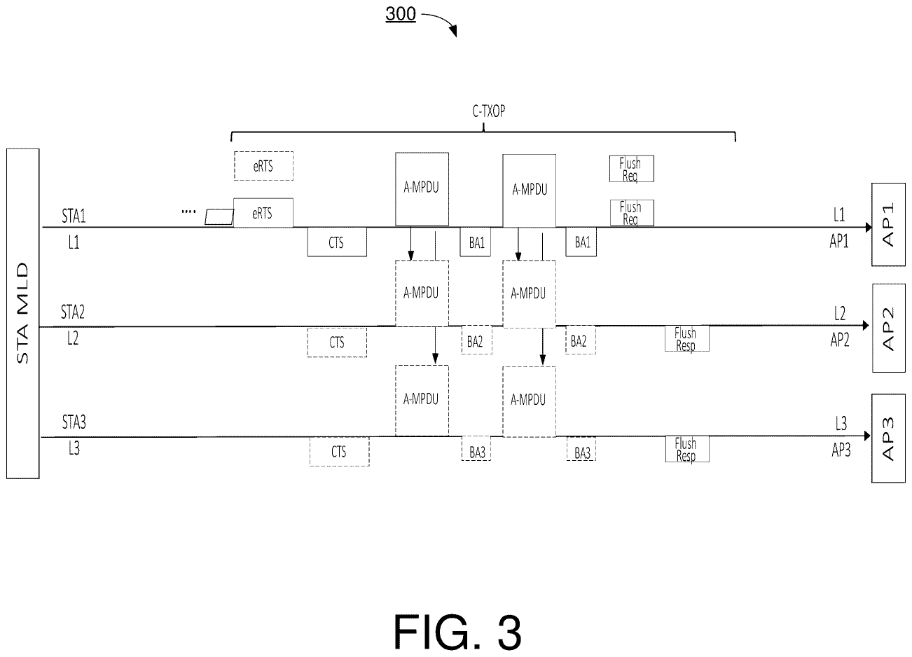

FIG. 3 illustrates an example scenario 300 under a proposed scheme in accordance with the present disclosure. Scenario 300 may pertain to setup of a coordinated TXOP (C-TXOP) with APs for UL coordinated reception (C-Rx) under a first option (Option 1). Referring to FIG. 3, STA1 affiliated with STA MLD may perform an enhanced distributed channel access (EDCA) to acquire a TXOP on an operating bandwidth. STA1 may send duplicated enhanced request-to-send (eRTS) on L1 (with recipient address (RA)=BSSID1, plus indication of C-Rx by non-collocated C-APs) to set up or otherwise establish a C-TXOP which is a synchronized TXOP for the neighboring APs. STA1 may specify C-APs in E-Link ID(s) and/or SCH(s) for responding clear-to-send (CTS) in the MAC header of the eRTS to set up or otherwise establish a C-TXOP. Each of AP1, AP2 and AP3 may send a CTS on the specified SCH(s) of L1, L2 and L3, respectively, and set up or otherwise establish the same C-TXOP. STA1 may then send an aggregate MPDU (A-MPDU) with Color Code (CC)=0) on L1 (depending on SCHs of CTS) with the same security key for data frame exchange. STA1 may include E-Link ID(s) and suggested, selected or otherwise specified SCH(s) in the MAC header to specify C-APs for C-Rx and BA response. In response, AP1, AP2 and AP3 may independently process the received MPDUS, manage BA status, adjust Tx power of BA, and send a BA on PCH or specified SCH(s) of L1, L2 and L3, respectively. The STA MLD may consolidate the BAs received on L1, L2 and L3 and may determine whether retransmission of a failed MPDU or transmission of new MAC service data units (MSDUs). In case that the consolidation of received BAs indicates the transmitted MPDUs are unsuccessful, STA1 may retransmit the missing MPDU(s). Otherwise, STA1 may send a Flush Request specifying AP2 and/or AP3 to flush their received MPDUs to AP1. The Flush Request may contain Flushing information element(s) (IE(s)) including E-Link ID, a bitmap for MPDUs to be flushed, and so on. Optionally, the Flushing IE(s) may be included in the A-Control field of an A-MPDU of subsequent frame exchange. AP2 and/or AP3 may send a Flush Response and may follow the instruction in the Flushing IE(s) to flush received MPDUs to AP1, and AP1 may forward a MSDU to the DS after consolidating all received MPDUs into a MSDU.

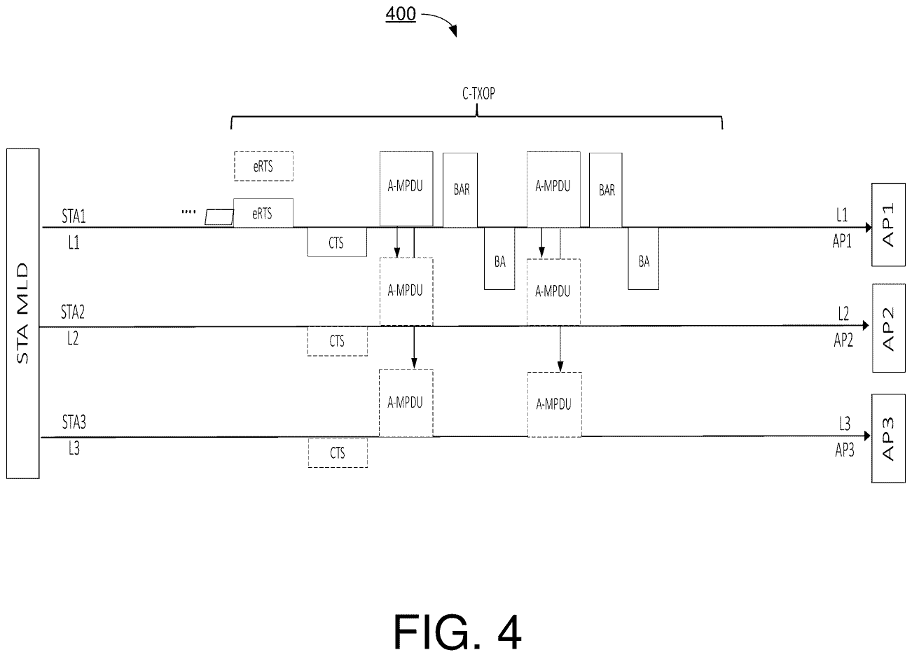

FIG. 4 illustrates an example scenario 400 under a proposed scheme in accordance with the present disclosure. Scenario 400 may pertain to setup of a C-TXOP with APs for UL C-Rx under a second option (Option 2). Referring to FIG. 4, STA1 affiliated with STA MLD may perform EDCA to acquire a TXOP on the operating bandwidth. STA1 may send duplicated eRTS's on L1 (with RA=BSSID1 (or MC), plus indication for C-Rx with non-collocated APs) to set up or otherwise establish a C-TXOP which is a synchronized TXOP for the neighboring APs. STA1 may also specify C-APs in E-Link ID(s) and/or SCH(s) for responding CTS in the MAC header of the eRTS to set up or otherwise establish a C-TXOP. In response, AP1, AP2 and AP3 may send a CTS on its P20 and specified SCH(s) of L1, L2 and L3, respectively, and AP1, AP2 and AP3 may set up or otherwise establish the same C-TXOP. STA1 may send an A-MPDU (CC=0) on L1 (depending on 20 SCHs of CTS) with the same security key for data frame exchange. C-APs (e.g., AP2 and AP3) may receive the A-MPDU over the shared channel and process the received MPDUs. AP2 and/or AP3 may immediately forward over backhaul connections the received MPDUs to AP1. AP MLD1 may consolidate, check and remove duplicated MPDUs. AP MLD1 may also maintain consolidated reception status in the BA score board. Then, STA1 may send a block acknowledgement request (BAR) to AP1 on L1, and AP1 may send a BA with the consolidated reception status to STA1 on L1. In case that the consolidated reception status from AP1 indicates the transmitted MPDUs are unsuccessful, STA1 may retransmit the missing MPDU(s). Otherwise, STA1 may send a new packet, if any. AP MLD1 may forward the consolidated received MPDUs to the DS.

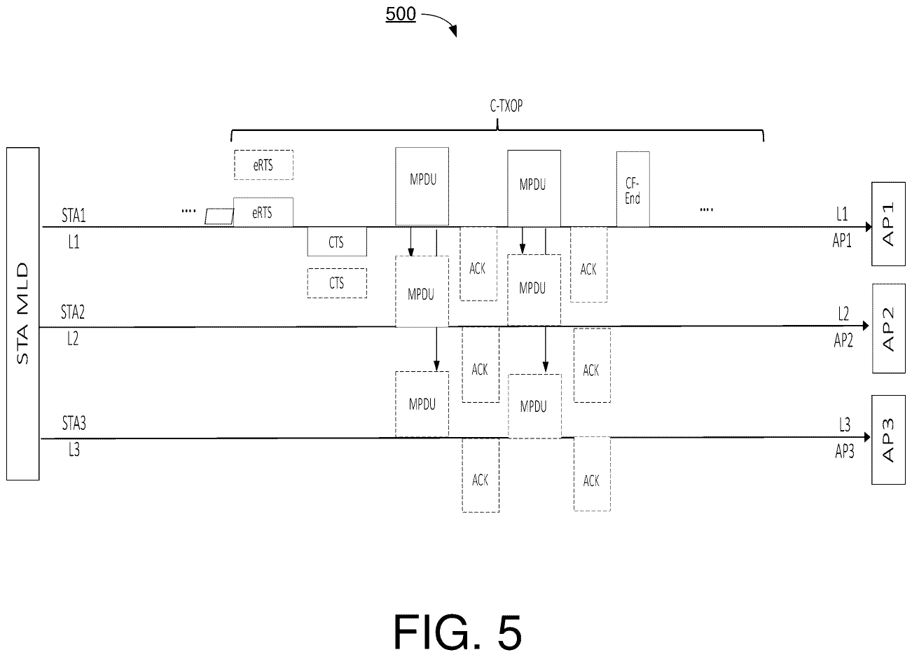

FIG. 5 illustrates an example scenario 500 under a proposed scheme in accordance with the present disclosure. Scenario 500 may pertain to setup of a C-TXOP with APs for UL C-Rx under a third option (Option 3). Referring to FIG. 5, STA1 affiliated with STA MLD may perform EDCA to acquire a TXOP on the operating bandwidth. STA1 may send duplicated eRTS's on L1 (with RA=BSSID1, plus indication for C-Rx with non-collocated APs) to set up or otherwise establish a C-TXOP which is a synchronized TXOP for the neighboring APs. STA1 may also specify C-APs in E-Link ID(s) in the MAC header of the eRTS to set up or otherwise establish a C-TXOP. In response, AP1, AP2 and AP3 may send a CTS on its P20 of L1, L2 and L3, respectively, and set up or otherwise establish the same C-TXOP which is a synchronized TXOP for the neighboring APs. STA1 may send an MPDU (CC=0) on L1 with the same security key for data exchange. STA1 may also include E-Link ID(s) in the MAC header to specify the C-APs. The C-APs (e.g., AP2 and AP3) may process the received MPDU. If any AP among the C-APs receives the MPDU successfully, it may send an acknowledgement (ACK). In case that STA1 does not receive any ACK, STA1 may retransmit the failed MPDU. Otherwise, STA1 may transmit new MSDUs, if any, or contention free-end (CF-End). The C-APs may flush the received MPDUs to AP1 over backhaul connections after the C-APs receive a new MPDU or CF-End from STA1. AP MLD1 may then forward the received MSDU(s) to the DS after removing duplicate of received MPDUs and consolidating them into MSDU(s).

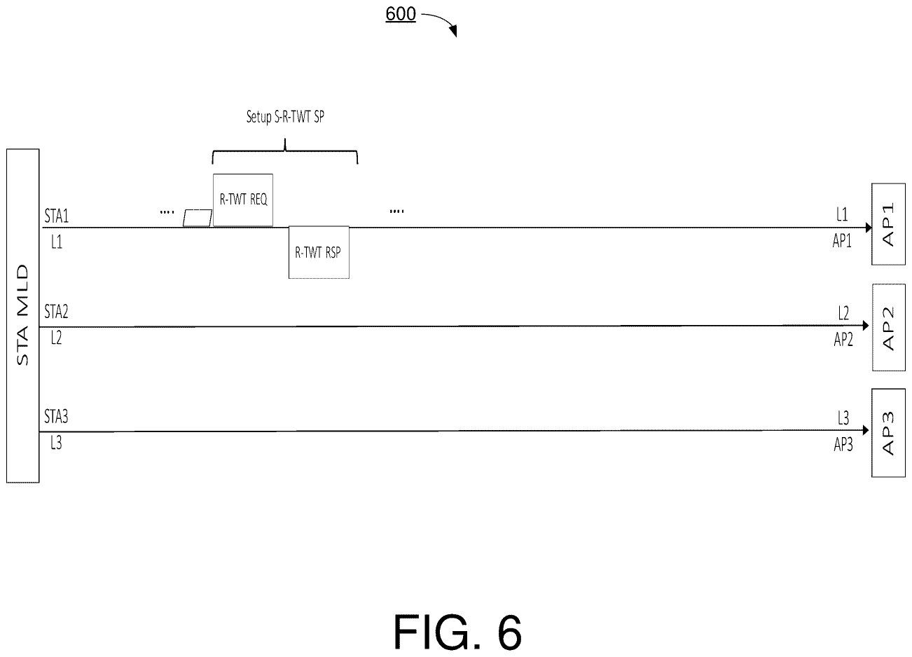

FIG. 6 illustrates an example scenario 600 under a proposed scheme in accordance with the present disclosure. Scenario 600 may pertain to scheduling of a synchronized R-TWT SP with APs. Referring to FIG. 6, STA1 affiliated with STA MLD may perform EDCA to acquire the wireless medium and send an R-TWT Request on L1 to set up or otherwise establish one or multiple synchronized R-TWT (S-R-TWT) SPs for C-APs to communicate with the STA MLD at the same time. STA1 may specify the C-APs in E-Link ID(s) for the R-TWT Response. AP1 or AP MLD1 may communicate with AP2 (or AP MLD2) and AP3 (or AP MLD3) for S-R-TWT SPs and send an R-TWT Response on L1 to STA1 with one or multiple schedules of S-R-TWT SPs for C-AP reception. The C-APs may schedule Quiet Periods overlapped with the S-R-TWT SPs to prevent non-SP member STAs from transmitting frames in any of the S-R-TWT SPs. All STAs on L1 or L2 or L3 may stop transmission prior to a given S-R-TWT SP.

Under a proposed scheme in accordance with the present disclosure with respect to setup of a C-TXOP with APs for UL C-Rx under a fourth option (Option 4), the procedure of setting up a C-TXOP with APs for UL C-Rx under Option 1, Option 2 and Option 3 may be implemented with an SP of an R-TWT. Under the proposed scheme, STA1 may initiate a setup procedure of C-TXOP with C-APs for UL C-Rx in a synchronized R-TWT SP.

In view of the above, certain highlights of the various proposed schemes are summarized below.

In a first aspect, a method of transmission reliability improvement in a multi-AP system may involve neighboring APs affiliated with an UHR MLD and a serving AP affiliated with the same UHR MLD. A synchronized TXOP may be set up and coordinated with APs selected (e.g., due to relatively higher CQI, SINR, and/or SNR) from the neighboring APs for a STA MLD.

In a second aspect, a method of transmission reliability improvement in a multi-AP system may involve a STA MLD communicating with coordinated APs in a synchronized TXOP. The STA MLD may transmit a packet to the coordinated APs over multiple links concurrently for coordinated reception. The STA MLD may consolidate BAs received from one or more of the coordinated APs and send information of consolidated success receiving status to the coordinated APs for them to flush the received packet.

In a third aspect, a method of transmission reliability improvement in a multi-AP system may involve a serving AP and coordinated APs connecting to the serving AP. The coordinated APs may concurrently receive UL packet(s) from a STA MLD over multiple links. The serving AP may consolidate packet(s) received by multiple APs of the coordinated APs, and the serving AP may also detect and remove duplicated packets.

In a fourth aspect, a method of transmission reliability improvement in a multi-AP system may involve neighboring APs affiliated with an UHR MLD and a serving AP affiliated with the same UHR MLD. A synchronized R-TWT SP may be set up or otherwise established with APs selected (e.g., due to relatively higher CQI and/or SINR) from the neighboring APs for a STA MLD. The synchronized R-TWT SP may include one or more synchronized TXOPs.

### Illustrative Implementations

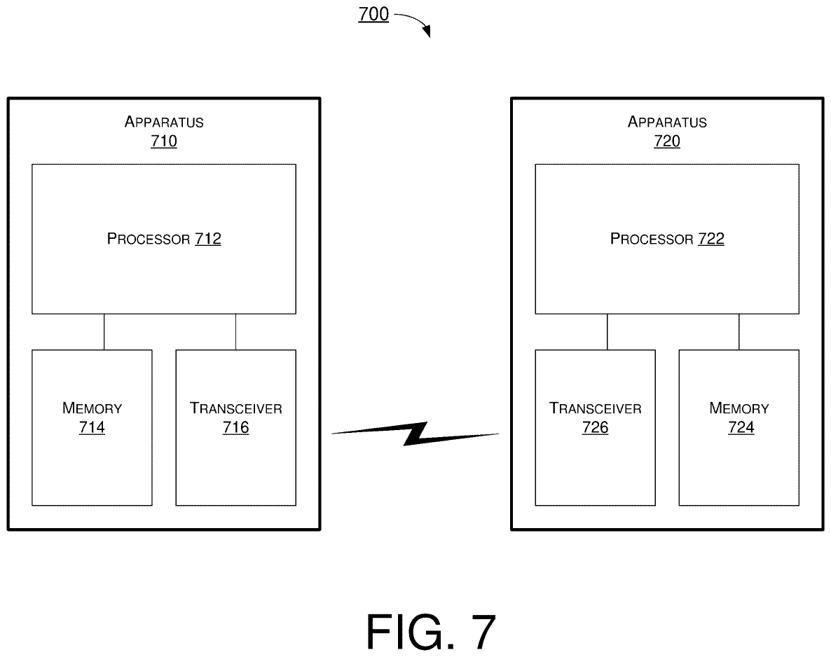

FIG. 7 illustrates an example system 700 having at least an example apparatus 710 and an example apparatus 720 in accordance with an implementation of the present disclosure. One or each of apparatus 710 and apparatus 720 may perform various functions to implement schemes, techniques, processes and methods described herein pertaining to improvement of multi-AP MLD network reliability in wireless communications, including the various schemes described above with respect to various proposed designs, concepts, schemes, systems and methods described above as well as processes described below. For instance, apparatus 710 may be implemented in STA 110 and apparatus 720 may be implemented in STA 120, or vice versa.

Each of apparatus 710 and apparatus 720 may be a part of an electronic apparatus, which may be a non-AP MLD or an AP MLD, such as a portable or mobile apparatus, a wearable apparatus, a wireless communication apparatus or a computing apparatus. When implemented in a non-AP MLD, each of apparatus 710 and apparatus 720 may be implemented in a smartphone, a smart watch, a personal digital assistant, a digital camera, or a computing equipment such as a tablet computer, a laptop computer or a notebook computer. Each of apparatus 710 and apparatus 720 may also be a part of a machine type apparatus, which may be an IoT apparatus such as an immobile or a stationary apparatus, a home apparatus, a wire communication apparatus or a computing apparatus. For instance, each of apparatus 710 and apparatus 720 may be implemented in a smart thermostat, a smart fridge, a smart door lock, a wireless speaker or a home control center. When implemented in or as a network apparatus, apparatus 710 and/or apparatus 720 may be implemented in a network node, such as an AP MLD in a WLAN.

In some implementations, each of apparatus 710 and apparatus 720 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. In the various schemes described above, each of apparatus 710 and apparatus 720 may be implemented in or as a non-AP MLD or an AP MLD. Each of apparatus 710 and apparatus 720 may include at least some of those components shown in FIG. 7 such as a processor 712 and a processor 722, respectively, for example. Each of apparatus 710 and apparatus 720 may further include one or more other components not pertinent to the proposed scheme of the present disclosure (e.g., internal power supply, display device and/or user interface device), and, thus, such component(s) of apparatus 710 and apparatus 720 are neither shown in FIG. 7 nor described below in the interest of simplicity and brevity.

In one aspect, processor 712 and processor 722 may be implemented in the form of one or more single-core processors, one or more multi-core processors, one or more RISC processors or one or more CISC processors. That is, even though a singular term “a processor” is used herein to refer to processor 712 and processor 722, processor 712 and processor 722 may include multiple processors in some implementations and a single processor in other implementations in accordance with the present disclosure. In another aspect, processor 712 and processor 722 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, processor 712 and processor 722 is a special-purpose machine specifically designed, arranged and configured to perform specific tasks including those pertaining to improvement of multi-AP MLD network reliability in wireless communications in accordance with various implementations of the present disclosure.

In some implementations, apparatus 710 may also include one or more transceivers 716 coupled to processor 712. Each of the one or more transceivers 716 may include a transmitter capable of wirelessly transmitting and a receiver capable of wirelessly receiving data. In some implementations, apparatus 720 may also include one or more transceivers 726 coupled to processor 722. Each of the one or more transceivers 726 may include a transmitter capable of wirelessly transmitting and a receiver capable of wirelessly receiving data. It is noteworthy that, although only one transceiver 716/1026 is shown in FIG. 7, in some implementations, apparatus 710 and/or apparatus 720 may be equipped with multiple transceivers 716 or multiple transceivers 726. For instance, apparatus 710 may have multiple transceiver 716 to configure a single-point association ML ESS network with multiple AP MLDs (e.g., multiple instances of apparatus 720 each of which functioning as or implemented in a corresponding AP MLD of the multiple AP MLDs).

In some implementations, apparatus 710 may further include a memory 714 coupled to processor 712 and capable of being accessed by processor 712 and storing data therein. In some implementations, apparatus 720 may further include a memory 724 coupled to processor 722 and capable of being accessed by processor 722 and storing data therein. Each of memory 714 and memory 724 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 714 and memory 724 may include a type of read-only memory (ROM) such as mask ROM, programmable ROM (PROM), erasable programmable ROM (EPROM) and/or electrically erasable programmable ROM (EEPROM). Alternatively, or additionally, each of memory 714 and memory 724 may include a type of non-volatile random-access memory (NVRAM) such as flash memory, solid-state memory, ferroelectric RAM (FeRAM), magnetoresistive RAM (MRAM) and/or phase-change memory.

Each of apparatus 710 and apparatus 720 may be a communication entity capable of communicating with each other using various proposed schemes in accordance with the present disclosure. For illustrative purposes and without limitation, a description of capabilities of apparatus 710, as a STA MLD, and apparatus 720, as an AP MLD, is provided below in the context of example process 800. It is noteworthy that, although the example implementations described below are provided in the context of WLAN, the same may be implemented in other types of networks. It is also noteworthy that, although examples described below are provided in the context of apparatus 710, the examples may also be applicable to apparatus 720 or otherwise implemented by apparatus 720.

### Illustrative Processes

FIG. 8 illustrates an example process 800 in accordance with an implementation of the present disclosure. Process 800 may represent an aspect of implementing various proposed designs, concepts, schemes, systems and methods described above. More specifically, process 800 may represent an aspect of the proposed concepts and schemes pertaining to improvement of multi-AP MLD network reliability in wireless communications in accordance with the present disclosure. Process 800 may include one or more operations, actions, or functions as illustrated by one or more of blocks 810, 820 and 830. Although illustrated as discrete blocks, various blocks of process 800 may be divided into additional blocks, combined into fewer blocks, or eliminated, depending on the desired implementation. Moreover, the blocks/sub-blocks of process 800 may be executed in the order shown in FIG. 8 or, alternatively, in a different order. Furthermore, one or more of the blocks/sub-blocks of process 800 may be executed repeatedly or iteratively. Process 800 may be implemented by or in apparatus 710 and apparatus 720 as well as any variations thereof. Solely for illustrative purposes and without limiting the scope, process 800 is described below in the context of apparatus 710 implemented in or a STA MLD and apparatus 720 implemented in or as an AP MLD of a wireless network such as a WLAN in network environment 100 in accordance with one or more of IEEE 802.11 standards. Process 800 may begin at block 810.

At 810, process 800 may involve processor 712 acquiring, via transceiver 716, a C-TXOP on multiple links. Process 800 may proceed from 810 to 820.

At 820, process 800 may involve processor 712 communicating, via transceiver 716, with multiple APs (e.g., including apparatus 720) over the multiple links. Each of the multiple APs may be affiliated with a respective AP MLD or UHR MLD and the multiple APs operate on a same channel in synchronization in a time domain.

In some implementations, in communicating with the multiple APs, process 800 may involve processor 712 communicating with a serving AP and coordinated APs that are selected from a plurality of neighboring APs based on a CQI or SINR.

In some implementations, in communicating with the multiple APs, process 800 may further involve processor 712 performing additional operations. For instance, process 800 may involve processor 712 transmitting duplicated eRTS messages on a first link of the multiple links to set up the C-TXOP, the duplicated eRTS messages indicating either or both of E-Link IDs of the multiple APs and one or more secondary channels for CTS. Moreover, process 800 may involve processor 712 receiving a CTS message from each of the multiple APs over the multiple links responsive to transmitting the duplicated eRTS messages.

In some implementations, in communicating with the multiple APs, process 800 may further involve processor 712 performing additional operations. For instance, process 800 may involve processor 712 transmitting an A-MPDU to the serving AP on the first link, the A-MPDU indicating the E-Link IDs of the coordinated APs and one or more suggested, selected or otherwise specified SCHs. Additionally, process 800 may involve processor 712 receiving BAs from the serving AP and the coordinated APs on the multiple links on a PCH or the one or more suggested, selected or otherwise specified SCHs. Moreover, process 800 may involve processor 712 consolidating the received BAs to determine whether retransmission is needed. Furthermore, process 800 may involve processor 712 either: (a) retransmitting one or more MPDUs responsive to determining that the A-MPUD was not successfully received; or (b) transmitting a flush request to at least one of the coordinated APs to cause the at least one of the coordinated APs to flush a respective received MPDU to the serving AP.

In some implementations, the flush request may include information of consolidated success receiving status.

In some implementations, in communicating with the multiple APs, process 800 may further involve processor 712 performing other operations. For instance, process 800 may involve processor 712 transmitting an A-MPDU to the serving AP on the first link, the A-MPDU indicating the E-Link IDs of the coordinated APs and one or more suggested, selected or otherwise specified SCHs. Moreover, process 800 may involve processor 712 transmitting a BAR to the serving AP on the first link. Furthermore, process 800 may involve processor 712 receiving a BA from the serving AP on the first link responsive to transmitting the BAR.

In some implementations, in communicating with the multiple APS, process 800 may further involve processor 712 performing different operations. For instance, process 800 may involve processor 712 transmitting an MPDU to the serving AP on the first link, the MPDU indicating the E-Link IDs of the coordinated APs. Additionally, process 800 may involve processor 712 receiving a BA from the serving AP or one of the coordinated APs. Moreover process 800 may involve processor 712 responsive to receiving the BA, transmitting either a new MPDU or a CF-End message.

In some implementations, in communicating with the multiple APs, process 800 may further involve processor 712 performing additional operations. For instance, process 800 may involve processor 712 scheduling a R-TWT SP with the multiple APs. Moreover, process 800 may involve processor 712 communicating with the multiple APs concurrently during one or more synchronized TXOPs within the R-TWT SP.

In some implementations, prior to acquiring the C-TXOP, process 800 may further involve processor 712 performing additional operations. For instance, process 800 may involve processor 712 discovering multiple neighboring BSS's associated with the multiple APs. Moreover, process 800 may involve processor 712 establishing, by the processor, the multiple links for an MLO. In some implementations, in discovering the multiple BSS's, process 800 may further involve processor 712 performing certain operations. For instance, process 800 may involve processor 712 transmitting a neighbor request to obtain information of neighboring APs among the multiple APs prior to moving to a different coverage area. Additionally, process 800 may involve processor 712 receiving one or more beacon frames from one or more of the neighboring APs.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
acquiring, by a processor of a station (STA) multi-link device (MLD), a coordinated transmission opportunity (C-TXOP) on multiple links; and
communicating, by the processor, with multiple access points (APs) over the multiple links,
wherein each of the multiple APs is affiliated with a respective AP MLD or Ultra-High Reliability (UHR) MLD and the multiple APs operate on a same channel in synchronization in a time domain.

2. The method of claim 1, wherein the communicating with the multiple APs comprises communicating with a serving AP and coordinated APs that are selected from a plurality of neighboring APs based on a channel quality indicator (CQI), signal-to-interference-and-noise ratio (SINR) or signal-to-noise ratio (SNR).

3. The method of claim 2, wherein the communicating with the multiple APs further comprises:
transmitting duplicated enhanced request-to-send (eRTS) messages on a first link of the multiple links to set up the C-TXOP, the duplicated eRTS messages indicating either or both of extended link identifiers (E-Link IDs) of the multiple APs and one or more secondary channels for clear-to-send (CTS); and
receiving a CTS message from at least one of the multiple APs over the multiple links responsive to transmitting the duplicated eRTS messages.

4. The method of claim 3, wherein each of the E-Link IDs comprises a respective AP identifier (ID) and a respective AP MLD ID.

5. The method of claim 3, wherein the communicating with the multiple APs further comprises:
transmitting an aggregate medium access control (MAC) protocol data unit (A-MPDU) to the serving AP on the first link, the A-MPDU indicating the E-Link IDs of the coordinated APs and one or more selected or specified secondary channels (SCHs);
receiving block acknowledgements (BAs) from the serving AP and the coordinated APs on the multiple links on a primary channel (PCH) or the one or more selected or specified SCHs;
consolidating the received BAs to determine whether retransmission is needed; and
either:
retransmitting one or more MPDUs responsive to determining that the A-MPUD was not successfully received; or
transmitting a flush request to at least one of the coordinated APs to cause the at least one of the coordinated APs to flush a respective received MPDU to the serving AP,
wherein the flush request includes information of consolidated success receiving status.

6. The method of claim 3, wherein the communicating with the multiple APs further comprises:
transmitting an aggregate medium access control (MAC) protocol data unit (A-MPDU) to the serving AP on the first link, the A-MPDU indicating the E-Link IDs of the coordinated APs and one or more selected or specified secondary channels (SCHs);
transmitting a block acknowledgement request (BAR) to the serving AP on the first link; and
receiving a block acknowledgement (BA) from the serving AP on the first link responsive to transmitting the BAR.

7. The method of claim 3, wherein the communicating with the multiple APs further comprises:
transmitting a medium access control (MAC) protocol data unit (MPDU) to the serving AP on the first link, the MPDU indicating the E-Link IDs of the coordinated APs;
receiving a block acknowledgement (BA) from the serving AP or one of the coordinated APs; and
responsive to receiving the BA, transmitting either a new MPDU or a contention free-end (CF-End) message.

8. The method of claim 2, wherein the communicating with the multiple APs further comprises:
scheduling a restricted target wake time (R-TWT) service period (SP) with the multiple APs; and
communicating with the multiple APs concurrently during one or more synchronized transmission opportunities (TXOPs) within the R-TWT SP.

9. The method of claim 1, prior to acquiring the C-TXOP, further comprising:
discovering, by the processor, multiple neighboring basic service sets (BSS's) associated with the multiple APs; and
establishing, by the processor, the multiple links for a multi-link operation (MLO).

10. The method of claim 9, wherein the discovering the multiple BSS's comprises:
transmitting a neighbor request to obtain information of neighboring APs among the multiple APs prior to moving to a different coverage area; and
receiving one or more beacon frames from one or more of the neighboring APs.

11. An apparatus implementable in a station (STA) multi-link device (MLD), comprising:
a transceiver configured to communicate wirelessly; and
a processor coupled to the transceiver and configured to perform operations comprising:
acquiring, via the transceiver, a coordinated transmission opportunity (C-TXOP) on multiple links; and
communicating, via the transceiver, with multiple access points (APs) over the multiple links,
wherein each of the multiple APs is affiliated with a respective AP MLD or Ultra-High Reliability (UHR) MLD and the multiple APs operate on a same channel in synchronization in a time domain.

12. The apparatus of claim 11, wherein the communicating with the multiple APs comprises communicating with a serving AP and coordinated APs that are selected from a plurality of neighboring APs based on a channel quality indicator (CQI), signal-to-interference-and-noise ratio (SINR) or signal-to-noise ratio (SNR).

13. The apparatus of claim 12, wherein the communicating with the multiple APs further comprises:
transmitting duplicated enhanced request-to-send (eRTS) messages on a first link of the multiple links to set up the C-TXOP, the duplicated eRTS messages indicating either or both of extended link identifiers (E-Link IDs) of the multiple APs and one or more secondary channels for clear-to-send (CTS); and
receiving a CTS message from at least one of the multiple APs over the multiple links responsive to transmitting the duplicated eRTS messages.

14. The apparatus of claim 13, wherein each of the E-Link IDs comprises a respective AP identifier (ID) and a respective AP MLD ID.

15. The apparatus of claim 13, wherein the communicating with the multiple APs further comprises:
transmitting an aggregate medium access control (MAC) protocol data unit (A-MPDU) to the serving AP on the first link, the A-MPDU indicating the E-Link IDs of the coordinated APs and one or more selected or specified secondary channels (SCHs);
receiving block acknowledgements (BAs) from the serving AP and the coordinated APs on the multiple links on a primary channel (PCH) or the one or more selected or specified SCHs;
consolidating the received BAs to determine whether retransmission is needed; and
either:
retransmitting one or more MPDUs responsive to determining that the A-MPUD was not successfully received; or
transmitting a flush request to at least one of the coordinated APs to cause the at least one of the coordinated APs to flush a respective received MPDU to the serving AP,
wherein the flush request includes information of consolidated success receiving status.

16. The apparatus of claim 13, wherein the communicating with the multiple APs further comprises:
transmitting an aggregate medium access control (MAC) protocol data unit (A-MPDU) to the serving AP on the first link, the A-MPDU indicating the E-Link IDs of the coordinated APs and one or more selected or specified secondary channels (SCHs);
transmitting a block acknowledgement request (BAR) to the serving AP on the first link; and
receiving a block acknowledgement (BA) from the serving AP on the first link responsive to transmitting the BAR.

17. The apparatus of claim 13, wherein the communicating with the multiple APs further comprises:
transmitting a medium access control (MAC) protocol data unit (MPDU) to the serving AP on the first link, the MPDU indicating the E-Link IDs of the coordinated APs;
receiving a block acknowledgement (BA) from the serving AP or one of the coordinated APs; and
responsive to receiving the BA, transmitting either a new MPDU or a contention free-end (CF-End) message.

18. The apparatus of claim 12, wherein the communicating with the multiple APs further comprises:
scheduling a restricted target wake time (R-TWT) service period (SP) with the multiple APs; and
communicating with the multiple APs concurrently during one or more synchronized transmission opportunities (TXOPs) within the R-TWT SP.

19. The apparatus of claim 11, prior to acquiring the C-TXOP, further comprising:
discovering, by the processor, multiple neighboring basic service sets (BSS's) associated with the multiple APs; and
establishing, by the processor, the multiple links for a multi-link operation (MLO).

20. The apparatus of claim 19, wherein the discovering the multiple BSS's comprises:
transmitting a neighbor request to obtain information of neighboring APs among the multiple APs prior to moving to a different coverage area; and
receiving one or more beacon frames from one or more of the neighboring APs.
